(19) United States
(12) Patent Application Publication
(10) Pub. No.: US 2023/0214713 A1
(43) Pub. Date: Jul. 6, 2023

(54) METHOD AND APPARATUS FOR COMMUNICATION EFFICIENT FEDERATED LEARNING WITH GLOBAL MODEL COMPRESSION

(71) Applicant: Samsung Electronics Co., Ltd., Gyeonggi-do (KR)

(72) Inventors: Yoo Jin CHOI, San Diego, CA (US); Mostafa EL-KHAMY, San Diego, CA (US); Sijia WANG, Durham, NC (US)

(21) Appl. No.: 17/824,558

(22) Filed: May 25, 2022

Related U.S. Application Data
(60) Provisional application No. 63/295,989, filed on Jan. 3, 2022.

(51) Int. Cl. G06N 20/00

(52) U.S. Cl. CPC G06N 20/00

(57) ABSTRACT

A server and method thereof are provided for use in a federated network. A method includes receiving local updates from client devices; updating a global model based on the received local updates; quantizing the updated global model; reconstructing feature maps based on the received local updates; refining the quantized, updated global model based on the reconstructed feature maps; and transmitting the refined, quantized, updated global model to the client devices.

### CROSS-REFERENCE TO RELATED APPLICATION(S)

This application is based on and claims priority under 35 U.S.C. § 119(e) to U.S. Provisional Patent Application Ser. No. 63/295,989, which was filed in the U.S. Patent and Trademark Office on Jan. 3, 2022, the entire content of which is incorporated herein by reference.

### FIELD

The disclosure relates generally to systems and methods providing framework of communication efficient federated learning.

### BACKGROUND

Federated learning allows multiple organizations or devices, e.g., mobile phones, to collaboratively learn a shared prediction model by making use of updating of locally available data on device and only communicate periodically with a central server with the intermediate updates, while keeping all the training data on device. Federated learning aims to collaboratively train a machine learning (ML) model while keeping the data decentralized.

FIG. 1 illustrates a typical example of federated learning.

Referring to FIG. 1, a single federated learning communication round includes two main stages. In the first stage, a subset of clients download a global model from a server, and update it locally with their local dataset. In the second stage, the clients upload their local updates to the server, which then aggregates the received local updates in order to update the global model.

In particular, a goal of federated learning is typically to minimize the following objective function of Equation (1):

$${min}_{w} F ( w ) , where F ( w ) : = \frac{1}{m} {\sum }_{k = 1}^{m} {F}_{k} ( w ) \qquad ( 1 )$$

In Equation (1), m is the total number of devices and Fₖ is the local objective function for the k-th device (or client). The local objective function is often defined as the empirical risk over local data, i.e., Fₖ(w)=E_{z˜P}_{ₖ}[Lₖ(w,z)], where z is a random variable with probability distribution Pₖ and the loss function Lₖ is used to measure how well the model performs. Pₖ can be considered as the underlying distribution of client k for generating data points, and realizations of the random variable z are the data points of client k.

Communication Efficient Federated Learning

Federated networks potentially consist of a massive number of devices (e.g., millions of smart phones), which have limited bandwidth and battery power compared to classical distributed learning in data centers, especially when it is desired to train highly iterative algorithms that also train on large datasets, like stochastic gradient descent.

Generally, communication efficient federated learning assumes perfect broadcasting of the global model from the parameter server to the clients, since downlink is often much faster than uplink. However, certain devices may not have sufficient bandwidth to receive global model updates when the model size is relatively large, particularly in the wireless setting. This may result in consistent exclusion of these devices, resulting in significant performance loss.

Moreover, the impact of quantization in the upload direction, i.e., the device to server direction, is less severe due to the impact of averaging local updates at the server.

### SUMMARY

Accordingly, this disclosure is provided to address at least the problems and/or disadvantages described above and to provide at least some of the advantages described below.

An aspect of the disclosure is to provide a novel framework of communication efficient federated learning.

Another aspect of the disclosure is to provide systems and methods for reducing downlink communication cost with compression (e.g., quantization) of the global model.

Another aspect of the disclosure is to provide systems and methods for reconstructing feature maps on a server from local updates, e.g., gradients, since there is no training data on the server.

Another aspect of the disclosure is to provide systems and methods for performing quantization bias correction with reconstructed feature maps on a server to reduce compression loss.

Another aspect of the disclosure is to provide systems and methods for performing quantization-aware training with reconstructed feature maps on a server to reduce compression loss.

Another aspect of the disclosure is to provide systems and methods for performing feature map mix-up with reconstructed feature maps on a server to improve performance of the global model.

In accordance with an aspect of the disclosure, a method is provided for a server in a federated network. The method includes receiving local updates from client devices; updating a global model based on the received local updates; quantizing the updated global model; reconstructing feature maps based on the received local updates; refining the quantized, updated global model based on the reconstructed feature maps; and transmitting the refined, quantized, updated global model to the client devices.

In accordance with another aspect of the disclosure, a server is provided for use in a federated network. The server includes a transceiver; and a processor configured to receive, via the transceiver, local updates from client devices, update a global model based on the received local updates, quantize the updated global model, reconstruct feature maps based on the received local updates, refine the quantized, updated global model based on the reconstructed feature maps, and transmit, via the transceiver, the refined, quantized, updated global model to the client devices.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 illustrates a typical example of federated learning;

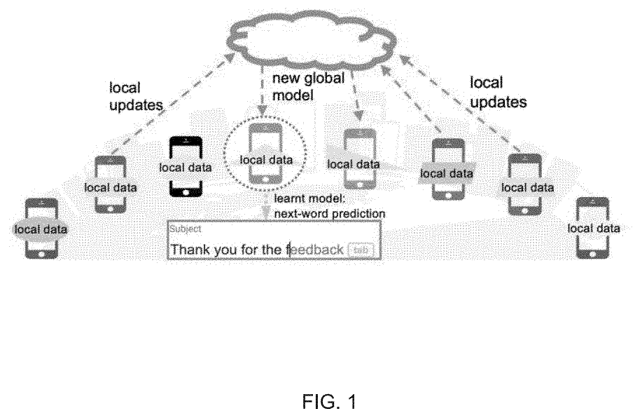

FIG. 2 illustrates an example of finding images that lead to similar changes in model prediction as an unobserved ground truth;

FIG. 3 is a flowchart illustrating a method of providing quantized global model updates from a server to clients, according to an embodiment;

FIG. 4 is a flowchart illustrating a method of refining quantized global model updates, according to an embodiment;

FIG. 5 is a flowchart illustrating a method of refining quantized global model updates, according to an embodiment;

FIG. 6 is a flowchart illustrating a method of refining quantized global model updates, according to an embodiment;

FIG. 7 is a flowchart illustrating a method of refining quantized global model updates, according to an embodiment; and

FIG. 8 illustrates an electronic device in a network environment, according to an embodiment.

### DETAILED DESCRIPTION

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

The electronic device according to one embodiment may be one of various types of electronic devices. The electronic devices may include, for example, a portable communication device (e.g., a smart phone), a computer, a portable multimedia device, a portable medical device, a camera, a wearable device, or a home appliance. According to one embodiment of the disclosure, an electronic device is not limited to those described above.

The terms used in the present disclosure are not intended to limit the present disclosure but are intended to include various changes, equivalents, or replacements for a corresponding embodiment. With regard to the descriptions of the accompanying drawings, similar reference numerals may be used to refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, terms such as “1st,” “2nd,” “first,” and “second” may be used to distinguish a corresponding component from another component, but are not intended to limit the components in other aspects (e.g., importance or order). It is intended that if an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wired), wirelessly, or via a third element.

As used herein, the term “module” may include a unit implemented in hardware, software, or firmware, and may interchangeably be used with other terms, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC). A framework for communication efficient federated learning is disclosed herein. The framework allows the compression of the global model before transmitting from the parameter server to clients, and thus can reduce the downlink transmission cost when the size of model is particularly large. Since the parameter server in a federated learning setting does not allow the storage of original training data, compression performance can be low due to no available data. The framework enables the server to have reconstructed feature maps of the original dataset, so that they can be used in the process of model compression.

In according with an embodiment of the disclosure, a novel framework of communication efficient federated learning is provided. Since there is no training data on a server, feature maps are reconstructed on the server from local updates, e.g., local gradients. Further, different methods are provided for using the reconstructed feature maps in global model training and quantization error calibration, which are reconstructed feature map mix-up and quantization bias compensation with reconstructed feature map. These approaches further improve and preserve global model performance when global model compression from server to clients is performed.

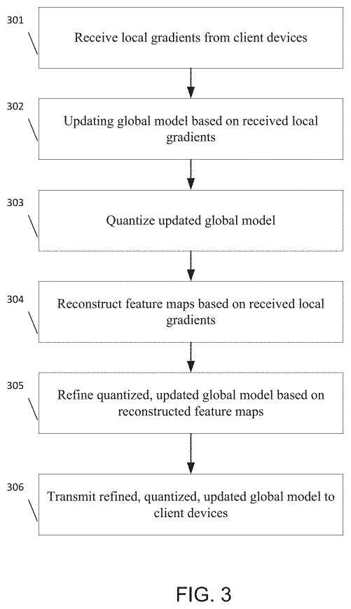

FIG. 3 is a flowchart illustrating a method of proving compressed global model updates from a server to clients, according to an embodiment.

Referring to FIG. 3, in step 3, a server receives local updates from client devices. For example, the local gradients may include gradients of the ML model that are computed at the client devices based on their local data, and are then transmitted to the server for aggregation and global model updating.

In step 302, the server updates the global model based on the received local gradients.

In step 303, the server quantizes (e.g., compresses) the updated global model.

In step 304, the server reconstructs features maps based on the received local gradients, e.g., by inverting the local gradients.

The reconstruction of input data from gradient information is possible for realistic deep and non-smooth architectures with both trained and untrained parameters.

Previous reconstruction algorithms generally rely on two components: (1) the Euclidean cost function and (2) optimization via a Limited memory Broyden-Fletcher-Goldfarb-Shanno algorithm (L-BFGS). However, these choices are not necessarily optimal for more realistic architectures; especially, arbitrary parameter vectors.

If a parameter gradient is decomposed into its norm magnitude and its direction, the magnitude only captures information about the state of training, measuring local optimality of the data point with respect to the current model. In contrast, a high-dimensional direction of the gradient can carry significant information, as the angle between two data points quantifies the change in prediction at one data point when taking a gradient step towards another. As such, a cost function may be used based on angles, i.e., cosine similarity,

$$l ( x , y ) = \frac{< x , y >}{( ‖ x ‖ ‖ y ‖ )} .$$

The objective is to find images that lead to similar changes in model prediction as the (unobserved) ground truth. This may be equivalent to minimizing the Euclidean cost function, if both gradient vectors are additionally constrained to be normalized to a magnitude of 1.

A search space may also be constrained to images within [0,1] and to add only total variation as a simple image prior to the overall problem shown in Equation (2):

$$arg {min}_{\{ x ∈ {[ 0 , 1 ]}^{n} \}} ( 1 - \frac{< {∇}_{θ} {L}_{θ} ( x , y ) , {∇}_{θ} {L}_{θ} ( {x}^{*} , y ) >}{‖ {∇}_{θ} {L}_{θ} ( x , y ) ‖ ‖ {∇}_{θ} {L}_{θ} ( {x}^{*} , y ) ‖} ) + α T V ( x ) \qquad ( 2 )$$

In Equation (2), x is the input image and y is the ground-truth label for input x, ∇_{θ}L_{θ}(x, y) is a transmitted gradient in which θ represents parameters of the federated network, and L represents a loss function, α is a hyper parameter that is greater than zero, which determines the weight for the total variation, and TV(x) is the total variation of x.

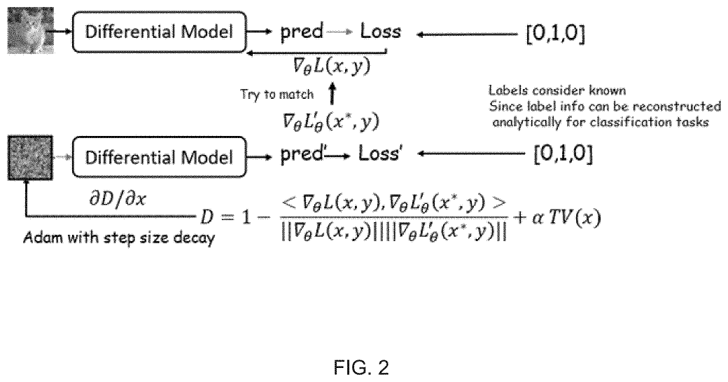

A goal of finding some inputs x in a given interval by minimizing a quantity that depends (indirectly, via their gradients) on the outputs of intermediate layers, is related to the task of finding adversarial perturbations for neural networks. As such, Equation (2) may be minimized based on the sign of its gradient, which may be optimized with an adaptive algorithm, such as Adaptive Momentum Estimation (Adam), with step size decay as shown in FIG. 2. Although signed gradients only affect the first and second order momentum for Adam, with the actual update step still being unsigned based on accumulated momentum, an image can still be accurately recovered.

In accordance with an embodiment, an input feature map may be reconstructed at each layer using Equation (3) as follows.

Let ƒ₁ be an input feature map of layer l. For the first layer (l=1), ƒ₁=x is the input image to the network. Let y be the ground-truth label for input x. The ground-truth label y can be predicted from the gradients.

Instead of Equation (2) shown above, the input feature map at each layer is reconstructed from Equation (3):

$${argmin}_{{f}_{l}} ( 1 - \frac{< {∇}_{θ} {L}_{θ} ( {f}_{l} , y ) , {∇}_{θ} {L}_{θ} ( {f}_{l}^{*} , y ) >}{‖ {∇}_{θ} {L}_{θ} ( {f}_{l} , y ) ‖ ‖ {∇}_{θ} {L}_{θ} ( {f}_{l}^{*} , y ) ‖} ) + α TV ( {f}_{l} ) . \qquad ( 3 )$$

In step 305, the server refines the quantized, updated global model based on reconstructed feature maps. For example, the reconstructed feature maps may be used for quantization bias compensation and/or for quantization-aware training of the compressed global model as will be described below.

In step 306, the server sends the refined, quantized, updated global model to the clients.

Although the method of FIG. 3 is described above with reference to local gradients as an example of local updates, the present disclosure is not limited thereto. For example, the local updates may include trained weights of local models, training gradients of the local models, feature maps from the local model, corresponding derived information, etc.

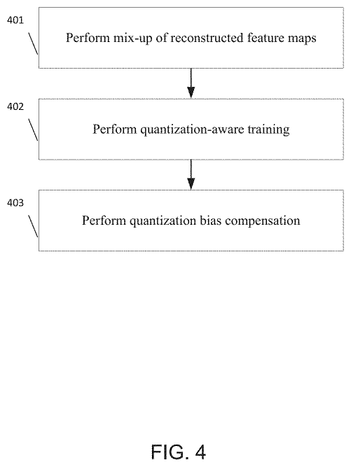

FIG. 4 is a flowchart illustrating a method of refining quantized global model updates, according to an embodiment.

Referring to FIG. 4, in step 401, the server performs a mix-up of the reconstructed feature maps. For example, for a pair of feature maps ƒ₁ and ƒ₂, they may be mixed with a mixing weight A as shown in Equation (4):

ƒ(λ)=λƒᵢ+(1−λ)ƒ₂ (4)

Thereafter, the mixed feature map ƒ may be used. The mixing parameter A may be generated as a random number from a beta distribution β defined in Equation (5) by:

$$β ( x ; α , α ) = \frac{{{x}^{α - 1} ( 1 - x )}^{α - 1}}{{\int }_{0}^{1} {{x}^{α - 1} ( 1 - x )}^{α - 1} dx} \qquad ( 5 )$$

The corresponding one-hot encoded label vectors y₁ and y₂ are also mixed with the same mixing weight λ as in Equation (6):

y(λ)=λy₁+(1−λ)y₂ (6)

In step 402, the server performs quantization-aware training. That is, weights of the global model may be trained by minimizing a cross-entropy loss defined by using the mixed feature maps ƒ(A) and the mixed label vector y(λ). For quantization-aware training, the weights of upper layers, given the reconstructed feature maps at layer l, are fine-tuned by quantization-aware training.

In step 403, the server performs quantization bias compensation (or correction).

More specifically, quantization error on the global weights in step 303 of FIG. 3 may introduce bias error on the corresponding outputs. This may shift the input distribution of the next layer, which may cause unpredicted effects. Accordingly, to correct for this bias error, quantization bias may be compensated in step 403 with the mixed-up reconstructed feature maps as follows.

Let Wₗ and Wₗ^{q} be the original floating-point weights and the quantized weights, respectively, and let ƒₗ be the input feature map for layer l. For quantized networks, yₗ^{q}=Wₗ^{q}*ƒₗ, where * denotes convolution for convolutional layer l. The quantization error at layer l is then defined as in Equation (7):

Qₗ^{err}=E_{ƒ}_{ₗ}[(Wₗ^{q}−Wₗ)*ƒₗ]=(Wₗ−Wₗ^{q})*E_{ƒ}_{ₗ}[ƒₗ]. (7)

In Equation (7), E_{ƒ}_{ₗ} represents an implied expectation with respect to feature map ƒₗ.

By letting Qₗ^{err}[h, w, c] be the quantization error at height h, width w, and channel c for the output feature map of size Hₗ×Wₗ×Cₗ, the average quantization error may be computed for each output channel c in Equation (8):

$${Q}_{l}^{err} [ c ] = \frac{1}{{H}_{l} {W}_{l}} {\sum }_{h = 1}^{{H}_{l}} {\sum }_{w = 3}^{{W}_{l}} {Q}_{l}^{err} [ h , w , c ] , 1 \leq c \leq {C}_{l} . \qquad ( 8 )$$

The quantization bias (i.e., quantization error) may then be compensated by Equation (9):

yₗ^{q+bias_comp}=W_{q}*ƒₗ+Qₗ^{err} (9)

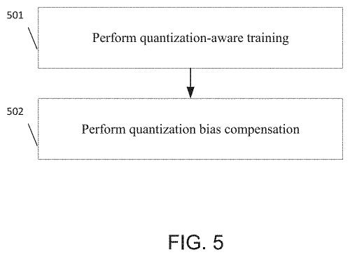

FIG. 5 is a flowchart illustrating a method of refining quantized global model updates, according to an embodiment.

Referring to FIG. 5, the method therein is similar to that in FIG. 4, except that the server does not perform a mix-up of the reconstructed feature maps. As such, the server performs quantization-aware training in step 501, and quantization bias compensation in step 502 based on the original reconstructed feature maps generated in step 304 of FIG. 3, instead of based on mixed-up reconstructed feature maps, as in FIG. 4.

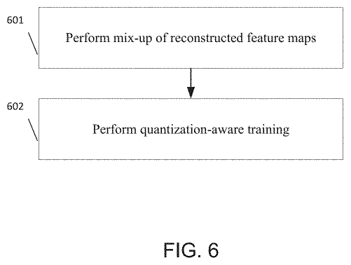

FIG. 6 is a flowchart illustrating a method of refining quantized global model updates, according to an embodiment.

Referring to FIG. 6, the method therein is similar to that in FIG. 4, except that the server does not perform quantization bias compensation. As such, the server performs a mix-up of the reconstructed feature maps in step 601, and quantization-aware training in step 602.

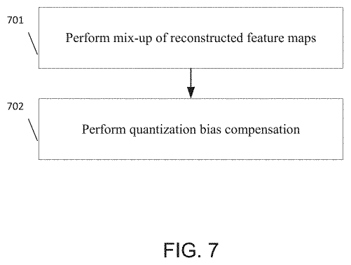

FIG. 7 is a flowchart illustrating a method of refining quantized global model updates, according to an embodiment.

Referring to FIG. 7, the method therein is similar to that in FIG. 4, except that the server does not perform quantization-aware training. As such, the server performs a mix-up of the reconstructed feature maps in step 701, and quantization bias compensation in step 702.

Although FIGS. 4 to 7 illustrate the server performing various combinations of quantization bias correction, mixing-up the reconstructed feature maps, and quantization-aware training, the disclosure is not limited thereto. As an alternative, the server may refine the quantized global model updates using only one of quantization bias correction, mixing-up the reconstructed feature maps, and quantization-aware training.

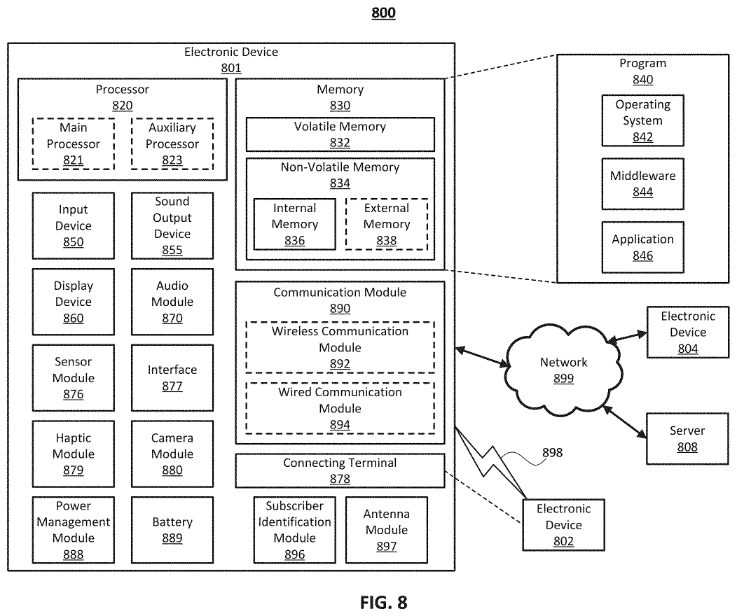

FIG. 8 illustrates an electronic device in a network environment, according to an embodiment.

Referring to FIG. 8, the electronic device 801, e.g., a mobile terminal including GPS functionality, in the network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) 896, or an antenna module 897 including a GNSS antenna. In one embodiment, at least one (e.g., the display device 860 or the camera module 880) of the components may be omitted from the electronic device 801, or one or more other components may be added to the electronic device 801. In one embodiment, some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute, for example, software (e.g., a program 840) to control at least one other component (e.g., a hardware or a software component) of the electronic device 801 coupled with the processor 820, and may perform various data processing or computations. As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor, and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). According to one embodiment, the auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input device 850 may receive a command or data to be used by other component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. According to one embodiment, the receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. According to one embodiment, the display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. According to one embodiment, the audio module 870 may obtain the sound via the input device 850, or output the sound via the sound output device 855 or a headphone of an external electronic device 802 directly (e.g., wiredly) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wiredly) or wirelessly. According to one embodiment, the interface 877 may include, for example, a high definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. According to one embodiment, the connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. According to one embodiment, the haptic module 879 may include, for example, a motor, a piezoelectric element, or an electrical stimulator.

The camera module 880 may capture a still image or moving images. According to one embodiment, the camera module 880 may include one or more lenses, image sensors, image signal processors, or flashes.

The power management module 888 may manage power supplied to the electronic device 801. The power management module 888 may be implemented as at least part of, for example, a power management integrated circuit (PMIC).

The battery 889 may supply power to at least one component of the electronic device 801. According to one embodiment, the battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the application processor) and supports a direct (e.g., wired) communication or a wireless communication. According to one embodiment, the communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module).

A corresponding one of these communication modules may communicate with the external electronic device via the first network 898 (e.g., a short-range communication network, such as Bluetooth™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. According to one embodiment, the antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

At least some of the above-described components may be mutually coupled and communicate signals (e.g., commands or data) therebetween via an inter-peripheral communication scheme (e.g., a bus, a general purpose input and output (GPIO), a serial peripheral interface (SPI), or a mobile industry processor interface (MIPI)).

According to one embodiment, commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

One embodiment may be implemented as software (e.g., the program 840) including one or more instructions that are stored in a storage medium (e.g., internal memory 836 or external memory 838) that is readable by a machine (e.g., the electronic device 801). For example, a processor of the electronic device 801 may invoke at least one of the one or more instructions stored in the storage medium, and execute it, with or without using one or more other components under the control of the processor. Thus, a machine may be operated to perform at least one function according to the at least one instruction invoked. The one or more instructions may include code generated by a complier or code executable by an interpreter. A machine-readable storage medium may be provided in the form of a non-transitory storage medium. The term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one embodiment, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A method performed by a server in a federated network, the method comprising:
receiving local updates from client devices;
updating a global model based on the received local updates;
quantizing the updated global model;
reconstructing feature maps based on the received local updates;
refining the quantized, updated global model based on the reconstructed feature maps; and
transmitting the refined, quantized, updated global model to the client devices.

2. The method of claim 1, wherein refining the quantized, updated global model based on the reconstructed feature maps comprises:
mixing-up the reconstructed feature maps;
performing quantization-aware training, based on the mixed-up reconstructed feature maps; and
performing quantization bias compensation, based on the mixed-up reconstructed feature maps.

3. The method of claim 2, wherein mixing-up the reconstructed feature maps is performed using:
ƒ(λ)=λƒ₁+(1−λ)ƒ₂,
wherein ƒ₁ and ƒ₂ represent a pair of feature maps, and A represents a mixing weight.

4. The method of claim 1, wherein refining the quantized, updated global model based on the reconstructed feature maps comprises:
performing quantization-aware training, based on the reconstructed feature maps; and
performing quantization bias compensation, based on the reconstructed feature maps.

5. The method of claim 1, wherein refining the quantized, updated global model based on the reconstructed feature maps comprises:
mixing-up the reconstructed feature maps; and
performing quantization-aware training, based on the mixed-up reconstructed feature maps.

6. The method of claim 1, wherein refining the quantized, updated global model based on the reconstructed feature maps comprises:
mixing-up the reconstructed feature maps; and
performing quantization bias compensation, based on the mixed-up reconstructed feature maps.

7. The method of claim 1, wherein refining the quantized, updated global model based on the reconstructed feature maps comprises one of:
mixing-up the reconstructed feature maps;
performing quantization-aware training, based on the reconstructed feature maps; or
performing quantization bias compensation, based on the reconstructed feature maps.

8. The method of claim 1, wherein the received local updates include received local gradients, and
wherein reconstructing feature maps based on the received local updates comprises inverting the received local gradients.

9. The method of claim 1, wherein reconstructing feature maps based on the received local updates is performed using:
$${argmin}_{{f}_{l}} ( 1 - \frac{< {∇}_{θ} {L}_{θ} ( {f}_{l} , y ) , {∇}_{θ} {L}_{θ} ( {f}_{l}^{*} , y ) >}{‖ {∇}_{θ} {L}_{θ} ( {f}_{l} , y ) ‖ ‖ {∇}_{θ} {L}_{θ} ( {f}_{l}^{*} , y ) ‖} ) + α TV ( {f}_{l} ) ,$$
wherein θ represents parameters of the federated network, L represents a loss function, ƒ₁ is an input feature map of layer l, where for a first layer (l=1), ƒ₁=x is an input image and y is a ground-truth label for input x, α is a hyper parameter that is greater than zero, and TV(x) is the total variation of x.

10. A server for use in a federated network, the server comprising:
a transceiver; and
a processor configured to:
receive, via the transceiver, local updates from client devices,
update a global model based on the received local updates,
quantize the updated global model,
reconstruct feature maps based on the received local updates,
refine the quantized, updated global model based on the reconstructed feature maps, and
transmit, via the transceiver, the refined, quantized, updated global model to the client devices.

11. The server of claim 10, wherein the processor is further configured to refine the quantized, updated global model based on the reconstructed feature maps by:
mixing-up the reconstructed feature maps;
performing quantization-aware training, based on the mixed-up reconstructed feature maps; and
performing quantization bias compensation, based on the mixed-up reconstructed feature maps.

12. The server of claim 11, wherein the processor is further configured to mix-up the reconstructed feature maps using:
ƒ(λ)=λƒ₁+(1−λ)ƒ₂,
wherein ƒ₁ and ƒ₂ represent a pair of feature maps, and A represents a mixing weight.

13. The server of claim 10, wherein the processor is further configured to refine the quantized, updated global model based on the reconstructed feature maps by:
performing quantization-aware training, based on the reconstructed feature maps; and
performing quantization bias compensation, based on the reconstructed feature maps.

14. The server of claim 10, wherein the processor is further configured to refine the quantized, updated global model based on the reconstructed feature maps by:
mixing-up the reconstructed feature maps; and
performing quantization-aware training, based on the mixed-up reconstructed feature maps.

15. The server of claim 10, wherein the processor is further configured to refine the quantized, updated global model based on the reconstructed feature maps by:
mixing-up the reconstructed feature maps; and
performing quantization bias compensation, based on the mixed-up reconstructed feature maps.

16. The server of claim 10, wherein the processor is further configured to refine the quantized, updated global model based on the reconstructed feature maps by:
mixing-up the reconstructed feature maps;
performing quantization-aware training, based on the reconstructed feature maps; or
performing quantization bias compensation, based on the reconstructed feature maps.

17. The server of claim 10, wherein the received local updates include received local gradients, and
wherein the processor is further configured to reconstruct the feature maps based on the received local updates by inverting the received local gradients.

18. The server of claim 10, the processor is further configured to reconstruct the feature maps based on the received local updates using:
$${argmin}_{{f}_{l}} ( 1 - \frac{< {∇}_{θ} {L}_{θ} ( {f}_{l} , y ) , {∇}_{θ} {L}_{θ} ( {f}_{l}^{*} , y ) >}{‖ {∇}_{θ} {L}_{θ} ( {f}_{l} , y ) ‖ ‖ {∇}_{θ} {L}_{θ} ( {f}_{l}^{*} , y ) ‖} ) + α TV ( {f}_{l} ) ,$$
wherein θ represents parameters of the federated network, L represents a loss function, ƒₗ is an input feature map of layer l, where for a first layer (l=1), ƒ₁=x is an input image and y is a ground-truth label for input x, α is a hyper parameter that is greater than zero, and TV(x) is the total variation of x.
